(19) United States
(12) Patent Application Publication
(10) Pub. No.: US 2018/0053178 A1
(43) Pub. Date: Feb. 22, 2018

(54) METHOD FOR FACILITATING DISPENSING FUEL INTO A VEHICLE

(71) Applicant: MASTERCARD INTERNATIONAL INCORPORATED, Purchase, NY (US)

(72) Inventor: Darshan Shah, Vadodara (IN)

(21) Appl. No.: 15/679,267

(22) Filed: Aug. 17, 2017

(30) Foreign Application Priority Data
Aug. 18, 2016 (SG) 10201606901S

(51) Int. Cl. G06Q 20/32

(52) U.S. Cl. CPC G06Q 20/3278; G06Q 20/16

(57) ABSTRACT

A method for facilitating to dispense of fuel into a vehicle is provided. The method includes receiving from the vehicle, a vehicle identifier for identifying the vehicle, retrieving payment vehicle, retrieving payment details, for payment for the fuel, from a remote server based on the vehicle identifier, and authorizing dispensing the fuel into the vehicle in accordance with the payment details.

### FIELD OF INVENTION

The present invention relates broadly, but not exclusively, to methods and systems for facilitating dispensing fuel into a vehicle.

### BACKGROUND

Over the last few decades electronic and physical payment transactions have increasingly involved the use of physical credit cards and the details of physical credit cards. Such payment transactions are ubiquitous and include, for example, payment for fuel at gas stations.

Currently, the fuel dispensing transactions happen with pay-at-pump technology, or in-store via cash or card. Once a user reaches the gas station, he can either swipe his card or pay in cash. In the case of a pay-at-pump transaction, the user does the authentication for his card using a zip code or other means of authentication, chooses the fuel grade and enters the dollar amount of fuel to be dispensed, or the volume of fuel to be dispensed. Finally he dispenses the fuel into the vehicle and collects a hard-copy of the receipt. The entire procedure for pay-at-pump is not so different from paying in cash.

In conventional fuel dispensing transactions, which include pay-at-pump and cash payments, there are several steps for users to execute in order to dispense fuel into their vehicles, as well as gas station attendant time in servicing customers who pay in-store. It is time consuming and troublesome for users to complete these steps, particularly during peak usage or refuelling period.

A need therefore exists to provide methods and systems for facilitating dispensing fuel into a vehicle that seek to address the above-mentioned problems.

### SUMMARY

According to a first aspect of the present invention, a method for facilitating to dispense of fuel into a vehicle is provided. The method includes receiving from the vehicle, a vehicle identifier for identifying the vehicle, retrieving payment vehicle, retrieving payment details, for payment for the fuel, from a remote server based on the vehicle identifier, and authorizing dispensing the fuel into the vehicle in accordance with the payment details.

According to a second aspect of the present invention, a method for facilitating dispensing of fuel into a vehicle is provided. The method includes receiving vehicle information of the vehicle, issuing an identifier of the vehicle based on the vehicle information, offering a plurality of fuel selections for dispensing into the vehicle, receiving a selected fuel selection, payment details and the identifier, and authorizing dispensing of the selected fuel selection into the vehicle identified by the identifier, in accordance with the payment details.

According to a third aspect of the present invention, a computing system for facilitating dispensing of fuel into a vehicle is provided. The computing system includes a receiver for receiving an identifier of the vehicle from the vehicle, a retrieving module for retrieving payment details for the fuel from a remote server using the identifier, an authorizing module for authorizing the dispensing of the fuel into the vehicle in accordance with the payment details.

According to a fourth aspect of the present invention, a computing system for facilitating dispensing of fuel into a vehicle is provided. The computing system includes a receiver for receiving vehicle information of the vehicle, an issuing module for issuing an identifier of the vehicle based on the vehicle information, an offering module for offering a plurality of fuel selections for dispensing into the vehicle, a receiver for receiving a selected fuel selection, payment details and the identifier; and an authorizing module for authorizing dispensing of the selected fuel selection into the vehicle identified by the identifier, in accordance with the payment details.

According to a fifth aspect of the present invention, a system for facilitating dispensing of fuel into a vehicle is provided. The system includes a computer. The computer includes at least one processor and at least one memory including computer program code. The at least one memory and the computer program code are configured to, with at least one processor, cause the computer at least to receive, from the vehicle, a vehicle identifier for identifying the vehicle, retrieve payment details, for payment for the fuel, from a remote server based on the vehicle identifier, authorize dispensing of the fuel into the vehicle in accordance with the payment details.

According to a sixth aspect of the present invention, a computer readable medium including computer program code for facilitating dispensing of fuel into a vehicle. The computer program code is configured to, with at least one processor, cause a computer at least to: receive, from the vehicle, a vehicle identifier for identifying the vehicle; retrieve payment details, for payment for the fuel, from a remote server based on the vehicle identifier; authorize dispensing of the fuel into the vehicle in accordance with the payment details.

Unless context dictates otherwise, the following terms will be given the meaning provided here:
“card” includes a credit card, debit card, virtual card, bank account, prepaid card or any other payment vehicle from which funds can be debited to affect a transaction;
“beacon device” is any device for transmitting a beacon signal. The beacon signal may be any type of signal wirelessly transmitted to receivers. In one example, the beacon device may be Bluetooth low energy device;
“attendant” refers to any person employed to assist with fuel dispensing at a gas station. The person may also verify that the vehicle has been filled with fuel in accordance with particular transaction details—for example, a desired dollar value of the fuel to be dispensed.
“pump” refers to any fuel dispensing facility at a gas station. For self-service pump, the pump may include a pump controller to open/close the nozzle valve to control the amount of fuel to dispense in accordance with the transaction details.
“dispense fuel”, “dispensing fuel”, “refueling” and similar will be understood to refer to the process by which fuel is dispensed from a fuel pump into a vehicle (i.e. the vehicle fuel tank is filled, partially or fully).
“one or more databases” refers to any database or databases located within a computing system or remote server such as a server of gas station or cloud server. The database or databases may each be a cloud database running on a cloud computing platform.
“transaction details” refers to any type of information with regard to transactions among two or more parties. This may include the identity of the parties to the transaction, that which is being transacted (e.g. fuel), payment details, the date and time of the transaction, etc. A transaction does not necessarily involve payment for products and/or services.
“payment details” refers to any type of information (e.g. value of the transaction, fuel being sold or dispensed if pre-paid, user or vehicle identity, price per litre of fuel, and date and time of transaction) with regard to payment transactions among two or more parties. The payment transactions involve payment for products and/or services.
“fuel” refers to (i) any fuel and not limited to gas(petrol), diesel, electricity, CNG, LPG; and (ii) any other liquid or gas consumed by vehicles, including but not limited to AUS32 (also known as DEF or AdBlue).

### BRIEF DESCRIPTION OF THE DRAWINGS

Embodiments of the invention will be better understood and readily apparent to one of ordinary skill in the art from the following written description, which provides examples only, and in conjunction with the drawings in which:

FIG. 1 shows a flow chart illustrating a method for facilitating dispensing of fuel according to present teachings;

FIG. 2 shows a flow chart illustrating a method for facilitating dispensing of fuel according to present teachings;

FIG. 3 shows a detailed workflow illustrating transactions between a consumer app and remote server, according to present teachings;

FIG. 4 shows a detailed workflow illustrating transactions between vehicle, pump/merchant application and remote server, according to present teachings;

FIG. 5 shows a flow chart illustrating a method for adding a vehicle to the system from a consumer app, according to present teachings;

FIGS. 6A to 6G show user interfaces on a consumer app for adding a vehicle on the system, according to present teachings;

FIG. 7 shows a flow chart illustrating a method for selecting fuel and making payment from a consumer app, according to present teachings;

FIGS. 8A to 8E show user interfaces on a consumer app for selecting fuel and making payment from the consumer app, according to present teachings;

FIG. 9 shows a flow chart illustrating a method for authorizing the dispensing of fuel into a vehicle using merchant app, according to present teachings;

FIGS. 10A to 10D show a user interface on merchant app for authorizing the dispensing of fuel into a vehicle, according to present teachings;

FIG. 11 shows a schematic of a system for facilitating dispensing fuel into a vehicle according to present teachings; and

FIG. 12 shows an exemplary computing device suitable for executing the method for facilitating dispensing fuel into a vehicle according to present teachings.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “retrieving”, “authorizing”, “issuing”, “offering” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

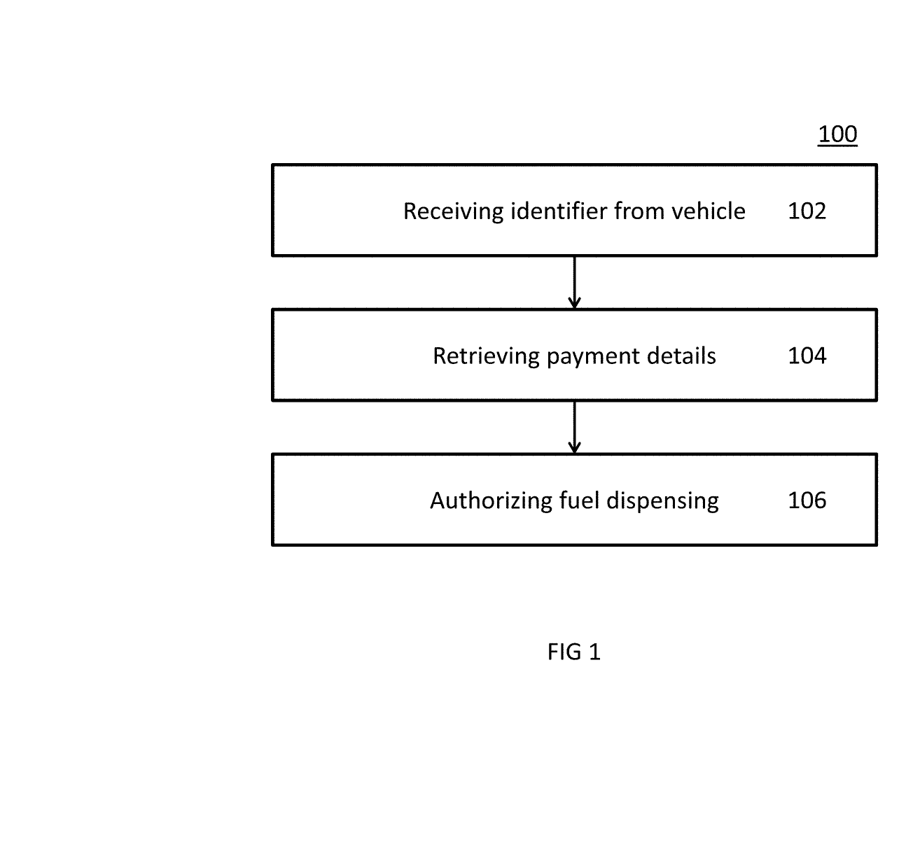

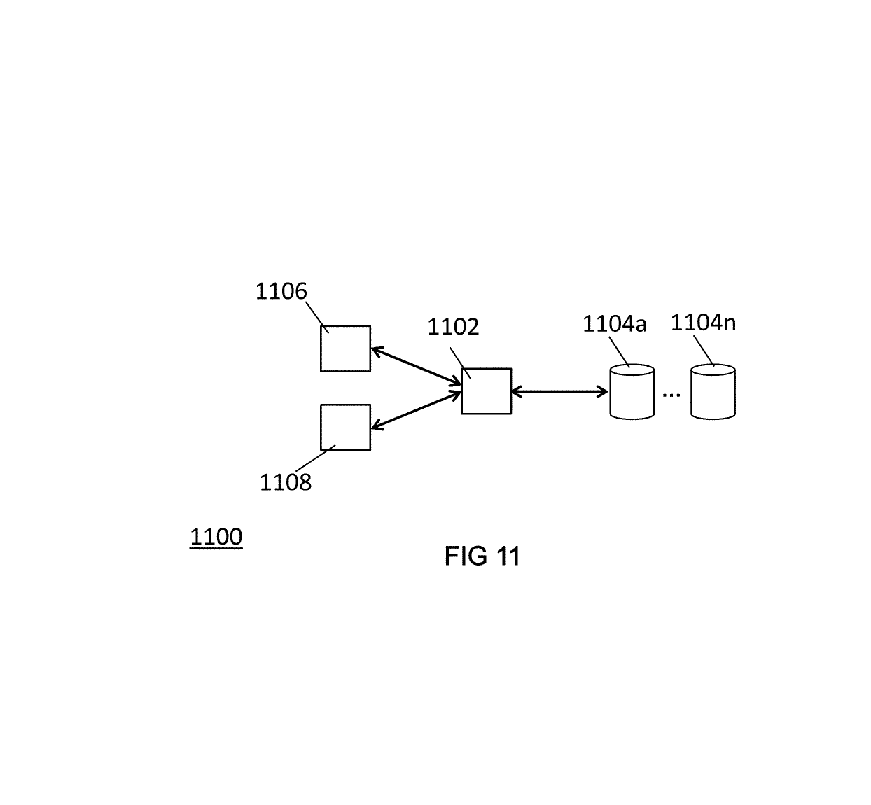

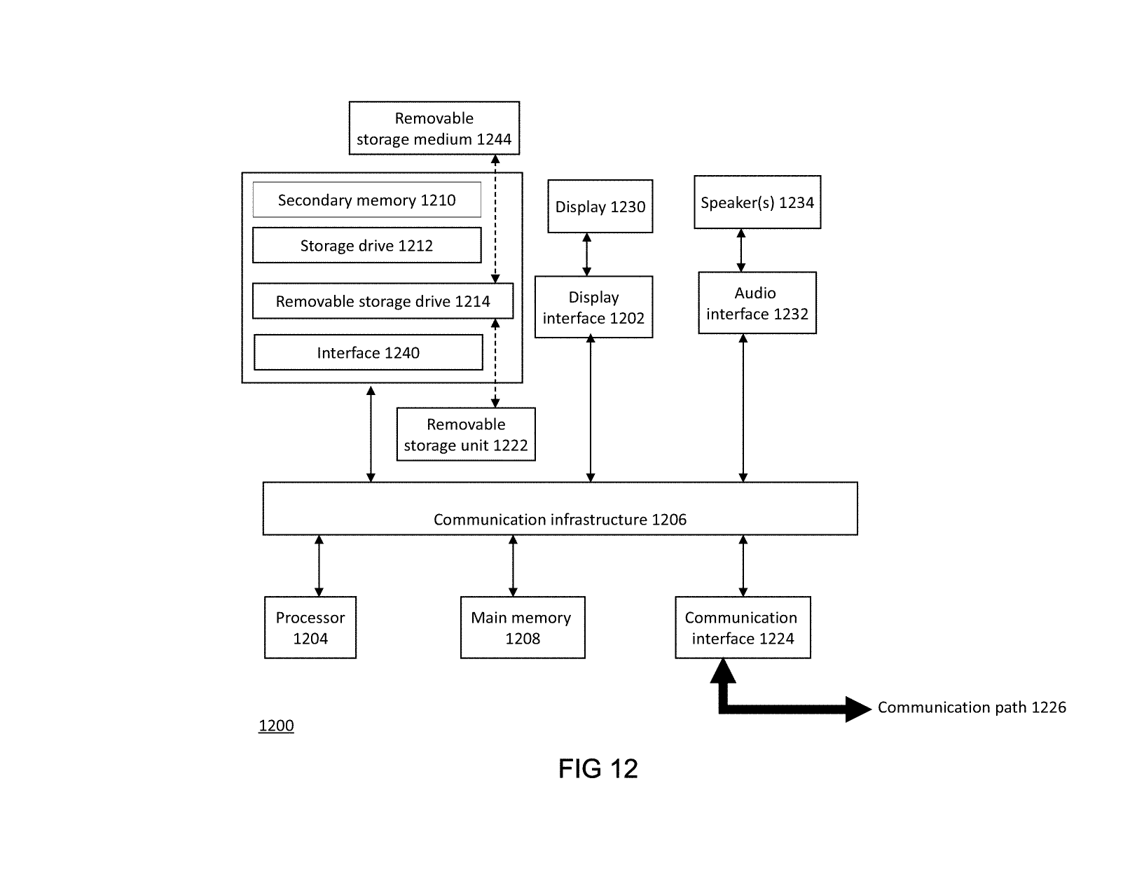

FIG. 1 shows a flow chart illustrating a method 100 for facilitating dispensing of fuel into a vehicle, according to an embodiment of the invention. The method 100 may be performed by a computer coupled to one or more databases. Furthermore, the method 100 may be performed by a computing device which may be a server system, mobile device (e.g. a smart phone or tablet computer) or a personal computer. Further details on the computer and databases will be provided below with reference to FIGS. 11 and 12.

The method 100 broadly comprises:
Step 102: receiving an identifier of the vehicle from the vehicle;
Step 104: retrieving payment details for the fuel from a remote server using the identifier; and
Step 106: authorizing dispensing of the fuel into the vehicle in accordance with the payment details.

Without loss of generality, the description will largely focus on embodiments of the invention relating to credit cards, though it will be understood to apply equally to debit cards or other payment means.

Step 102 involves receiving an identifier of the vehicle from the vehicle. The identifier may be provided to a pump or an attendant at a gas station to identify the vehicle. The identifier may be sent from a beacon device or beacon devices installed in the vehicle and received by a receiver coupled to a terminal for approval or viewing by an attendant, or by a receiver coupled to a controlling system for controlling operation of the relevant fuel pump at the gas station. Alternatively, the identifier may be sent from an RFID transponder device (for example attached to an electronic license plate) installed in the vehicle and received by a receiver coupled to a terminal for approval or viewing by an attendant, or by a receiver coupled to a controlling system for controlling operation of the relevant fuel pump at the gas station.

Where an attendant's terminal receives the identifier, the terminal provides the attendant with the details of the vehicle so that the attendant can identify the vehicle at the gas station. Similarly, where the pump control system receives the identifier, the control system may identify the vehicle by e.g. scanning QR code of transaction details which include information of the vehicle.

Step 104 may include retrieving payment details for payment for the fuel from a remote server using the vehicle identifier. The payment details may include one or more of a fuel type, fuel grade and quantity. Prior to Step 104, a driver or a passenger of the vehicle selects the fuel type, fuel grade and/or quantity to dispense and makes necessary payment for the selected item. The selections may be made dynamically for each refuelling operation, or may form a default transaction set up by the user during, or after, registering their vehicle in accordance with the method shown in FIG. 5. In one example, the driver or the passenger makes payment using a prepaid card, credit card or digital wallet. By completing the selection and payment before reaching the gas station, fuel dispensing time for each vehicle at the gas station is significantly reduced.

The fuel type may include petrol, diesel, LPG, etc. The fuel type depends on available fuel at the gas station where it is intended the vehicle should refuel. The fuel type also depends on fuel compatible with the vehicle. Some fuels are not appropriate for some types of vehicles. In one example, a mobile app on a mobile computing device such as smartphone displays fuels appropriate for the registered vehicle and that are available at the nearest gas station based on the current position of the smartphone (where GPS is used).

The fuel grade may include the octane rating or octane number of the fuel, the ethanol or additive content in the fuel. The driver or the passenger may select the fuel grade to be used in the refuelling operation, such as regular, plus, premium etc. Similar to the fuel type, the fuel grade depends on available fuel at the gas station where the vehicle is to refuel. The fuel grade also depends on fuel compatible with the vehicle. Users may register a preferred fuel type and fuel grade for the vehicle and proceed with the preferred option as long as the fuel type and fuel grade is available.

Once a fuel type has been selected, the pump controller may lock out nozzles for delivering fuels other than the selected fuel. This ensures that only the correct fuel is used for refuelling.

The quantity of the fuel may be selected by the user. In one example, the quantity to fill up the tank of the vehicle is automatically calculated using data from the central processing unit of the vehicle, that data comprising the type of vehicle or fuel tank volume and the residual quantity of the fuel in the tank of the vehicle. The quantity of the fuel can be selected based on the price of the fuel. For example, the user can dispense the amount of fuel corresponding to US$ 20. Alternatively, the quantity of the fuel can be selected by the volume, such as 6 gallons, 20 litres etc. Units of volume may be selected based on regional preference or user preference, or based on default transaction parameters as mentioned in relation to step 104.

Once the driver or a passenger selects the fuel and pays, the payment details are stored in the remote server together with the identifier of the vehicle. Accordingly, the attendant or the pump controller at the gas station can retrieve the payment details from the remote server using the identifier so that the attendant or the pump controller can confirm that the necessary payment has been completed. As the payment details include selection of fuel type, fuel grade or quantity, the attendant or the pump controller can proceed to fill the vehicle with the selected fuel with minimal, or no, delay.

Step 106 involves authorizing dispensing of the fuel into the vehicle in accordance with the payment details. Where the attendant at the gas station fills the vehicle with fuel, payment details may be displayed on a mobile terminal of the attendant and the attendant may identify the vehicle and fill the vehicle with the selected quantity of the selected fuel in accordance with the payment details. Where the pump controller controls dispensing of the fuel without an attendant, the payment details are processed in the pump controller. In one example, user may enter a passcode into a user interface by which the user or vehicle can be authenticated. For example, the user may enter their unique user identifier (e.g. a PIN code, social security number, Aadhaar number, tax file number etc) into the interface for authenticating himself or herself. Once the vehicle is identified by the pump controller, a fuel pump is activated to dispense the fuel in accordance with the payment details.

Where the pump controller controls pump operation without an attendant present, the driver or a passenger of the vehicle manually connects a pump to the tank of the vehicle. Alternatively, technology may be developed for automatically connecting the fuel tank opening to the pump or, in the case of electric vehicles, the vehicle charge point to the pump—the term “pump” in the case of an electric vehicle would be deemed to include a charge post or other charging mechanism for delivering charge to the batteries of the electric vehicle. Once the pump connects to the tank of the vehicle, manually or automatically, the pump controller opens a valve to allow the selected fuel to fill the tank using the pump. After dispensing the specified amount of fuel, which may simply be to fill the tank until full, the pump controller closes the valve to stop the flow of the fuel. As the payment details are processed in the pump controller, the step for selecting fuel and/or the step for paying for fuel are not required to be performed by the driver or a gas station attendant.

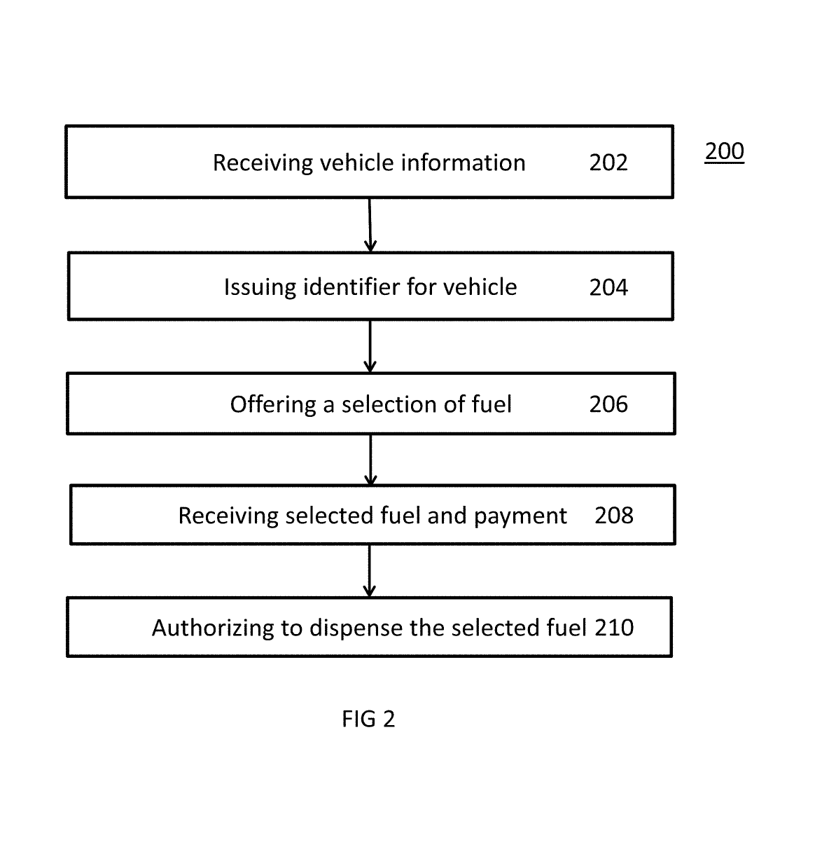

FIG. 2 shows a flow chart illustrating a method 200 for facilitating dispensing of fuel into a vehicle, according to an embodiment of the invention. The method 200 may be performed by a computer that is coupled to one or more databases. Furthermore, the method 200 may be performed by a computing device which may be a mobile device (e.g. a smart phone or tablet computer) or a personal computer. Further details on the computer and databases will be provided below with reference to FIGS. 11 and 12.

The method 200 broadly comprises:
Step 202: receiving vehicle information of the vehicle;
Step 204: issuing an identifier of the vehicle based on the vehicle information;
Step 206: offering a selection of fuel based on the vehicle information;
Step 208: receiving selected fuel and relevant payment together with the identifier; and
Step 210: authorizing filling the vehicle with the selected fuel.

Step 202 involves receiving vehicle information of the vehicle. In one example, a user submits the vehicle information using mobile app. The vehicle information is received by the remote server via the mobile app. The vehicle information may include a picture of the vehicle, information on the vehicle license plate, such as an index mark, registration number, or any other information by which the vehicle can be identified. The vehicle information may also include a preferred name for the vehicle which is shown on the mobile app of the user.

Step 204 involves issuing identifier for the vehicle. For each vehicle, a unique identifier is issued and stored in memory in associate with the vehicle information. In one example, a remote server issues the identifier in response to receiving the vehicle information. The vehicle information for each vehicle is stored in a database by a remote server. The identifier of the vehicle is stored in the database in association with the vehicle information so that the vehicle information can be retrieved by using the identifier for the vehicle. In one example, the identifier of the vehicle is issued when a user of the vehicle registers information of the vehicle.

Step 206 involves offering a selection of fuel. In one example, one or more gas stations near the vehicle are identified (e.g. using GPS location of the vehicle and of the gas station(s)) and information on the types of fuel available at gas station or gas stations is sent to a mobile app on a mobile computing device of the driver or passenger. The fuel information includes the types of available fuel, fuel grade etc. The fuel price is also sent to the mobile app. By using geolocation of mobile computing device of the user, the current location of the user and of gas stations near the user can be shown on a map. In one example, detailed information of a particular gas station is provided in response to selection of the particular gas station on the map. The detailed information of the gas station may include availability of an attendant, fuel price and available fuel types. Some drivers prefer self-service pumps and other drives prefer to ask an attendant to fill the vehicle with fuel. Detailed information may also include the availability of pumps, for example, where all pumps are presently in use, pumps are out of service or fuel supply of a relevant type of fuel has been temporarily exhausted at a particular gas station.

Step 208 involves receiving a selection of a particular fuel and payment for the fuel. The user (e.g. driver or passenger) may select fuel information which is offered by a remote server, including the fuel type, fuel grade, amount of fuel and total cost. The total cost may also be calculated by mobile app or remote server where a fuel volume is specified by the user. After calculation of the total cost, the user pays for the selected fuel by prepaid card or credit card or any other type of payment method. Notably, in this embodiment the selection of fuel and payment for the fuel is conducted before the vehicle reaches the pump. Accordingly, only fuel dispensing is conducted at the pump and time spent at the pump is substantially reduced.

Step 210 involves authorizing (i.e. activating) a pump to dispense the selected fuel. When the vehicle reaches the gas station, the vehicle is identified and payment for the fuel is verified—in other words, a server confirms payment has been made. Once the vehicle is identified and payment has been verified, a remote server authorises dispensing of the selected fuel into the vehicle. In response to the authorization, attendant may dispense the vehicle with the selected fuel. Alternatively, a self-service pump may be activated for the user to dispense the fuel into the vehicle.

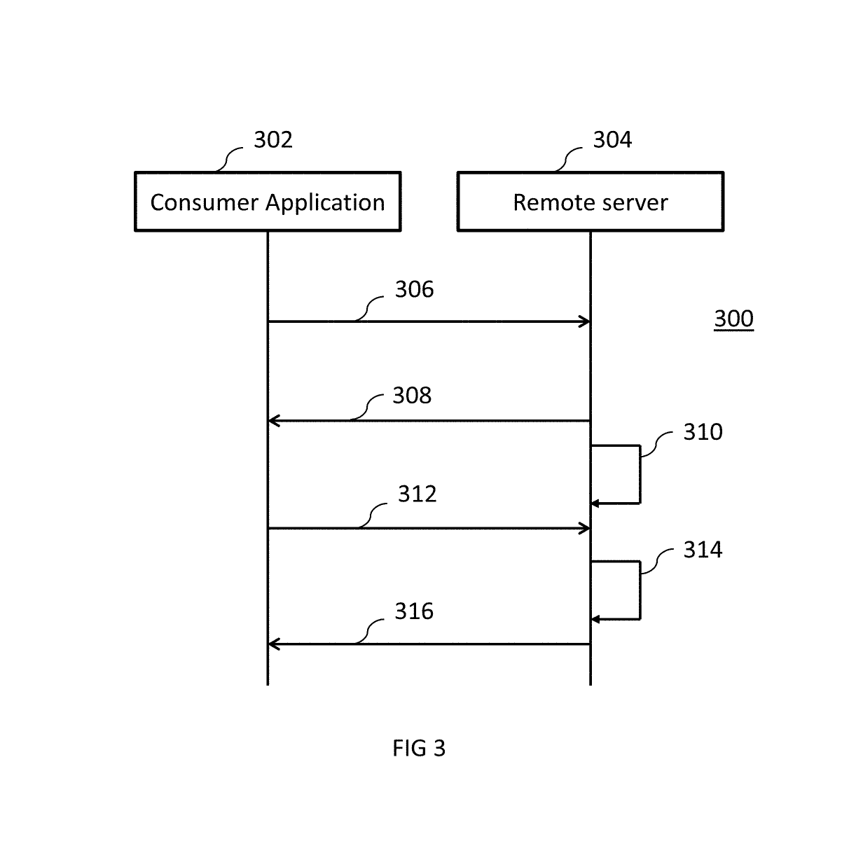

FIG. 3 shows a detailed workflow 300 illustrating transactions between a consumer app 302 and remote server 304, according to present teachings. Consumer app 302 may be installed on mobile computing device of the user. The mobile computing device may include smart watch, smart phone, any tablet computing device, or any other portable electronic device on which the app can be run. Alternatively, the consumer app 302 may be installed on computing device embedded on the vehicle itself. The consumer app 302 may be linked to the terminal for Electronic Road Pricing system. The remote server 304 includes a system interfacing with the consumer app 302 via any type of wireless network.

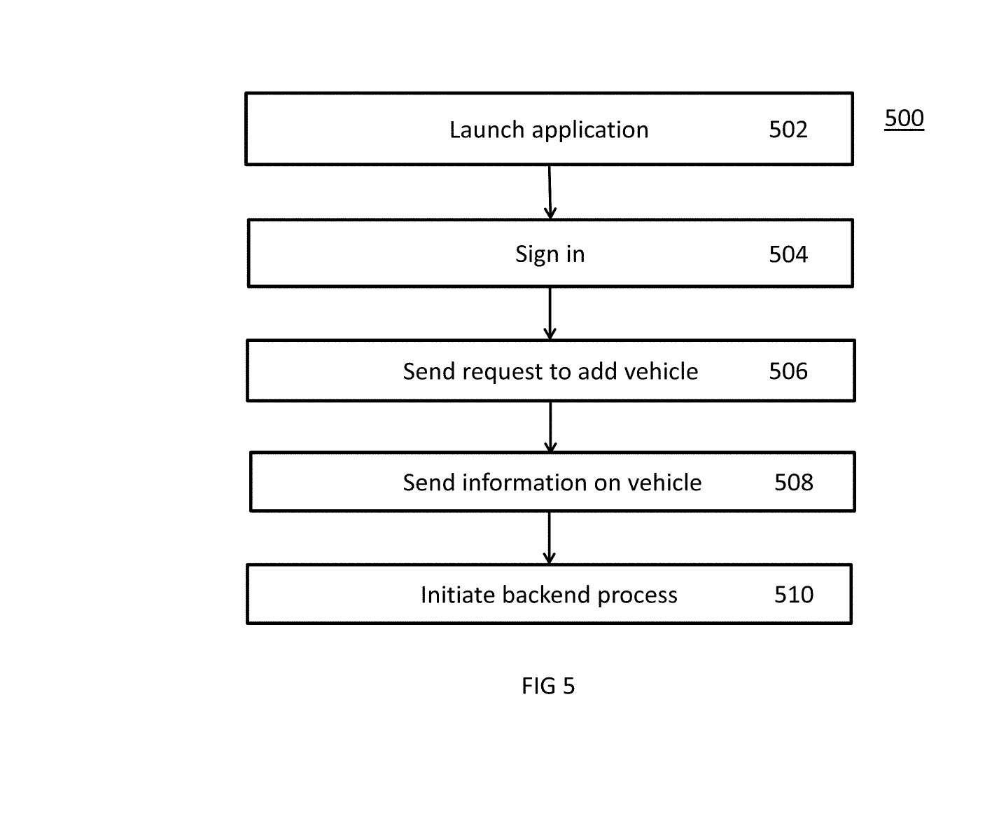

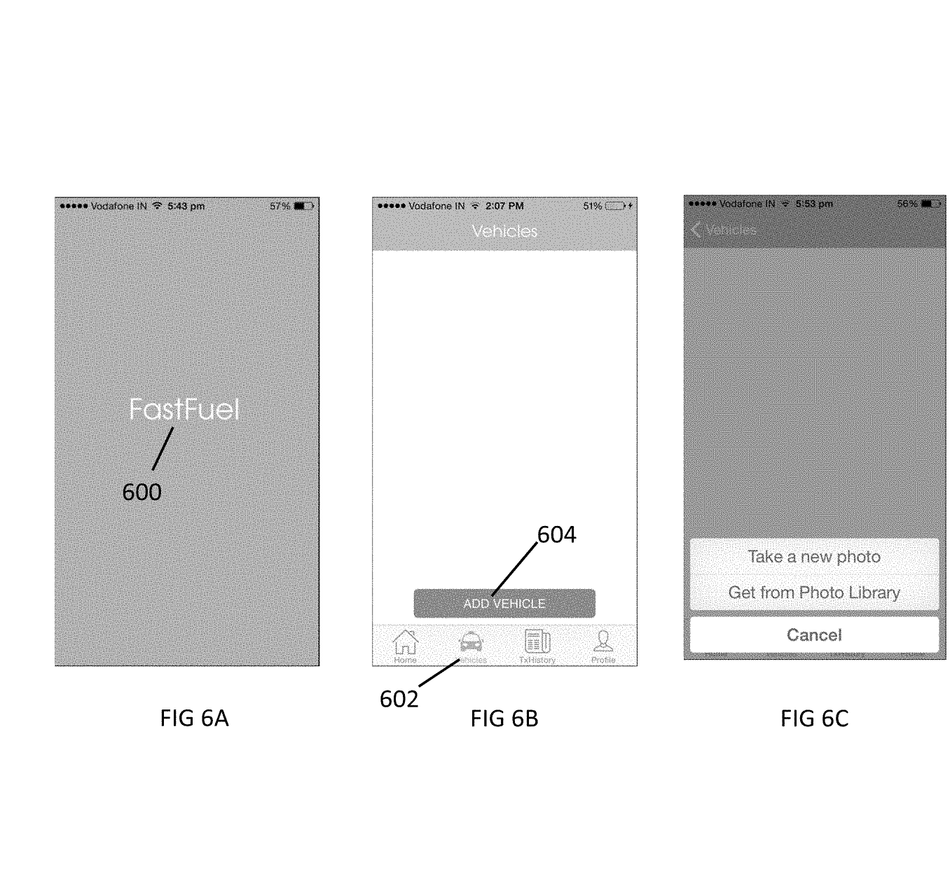

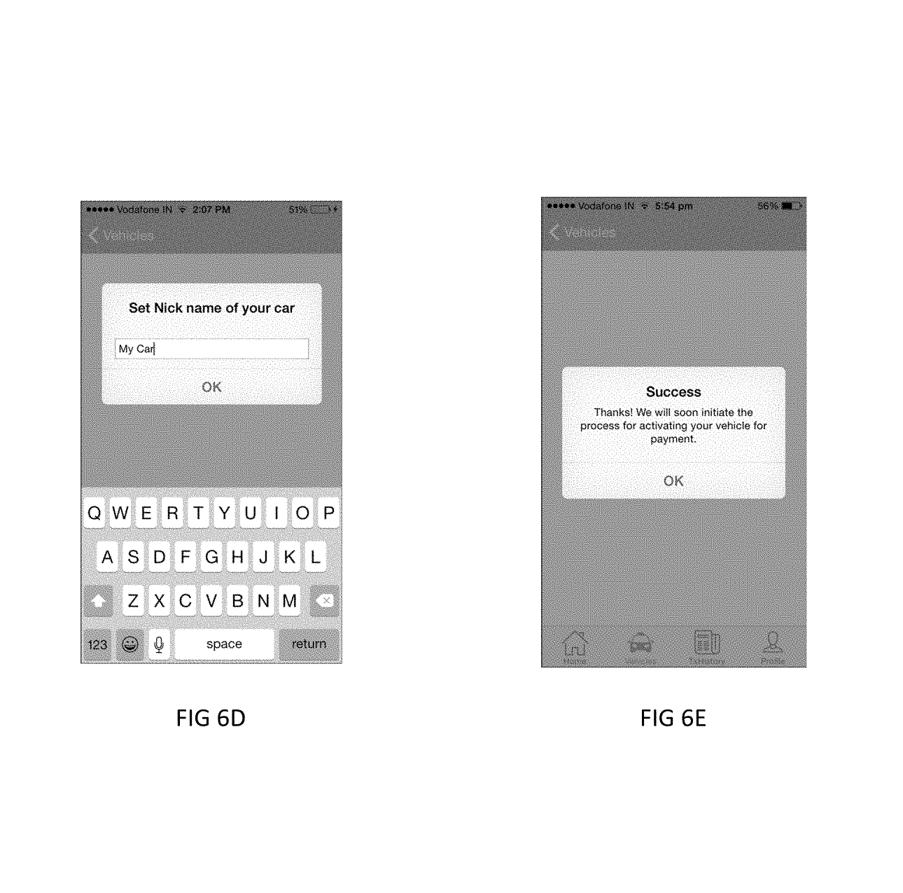

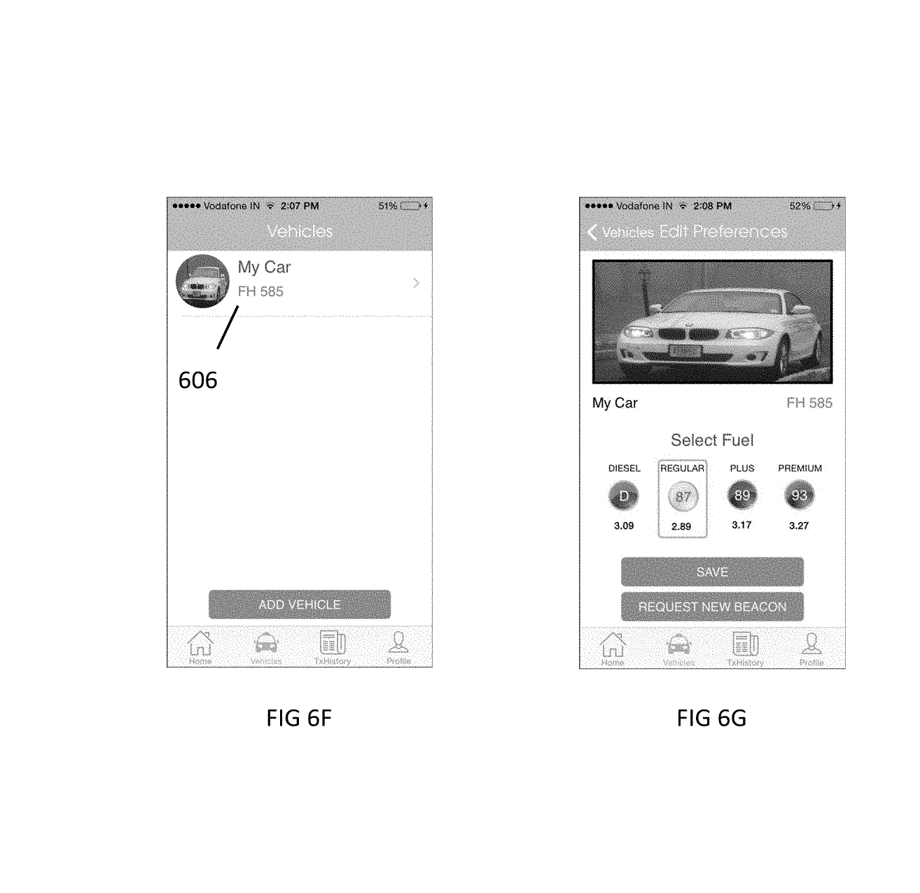

Step 306 involves adding vehicle on the system of the remote server 304 using consumer app 302. The user inputs vehicle information into the consumer app 302 and the vehicle information is transferred to the remote server 304. Detailed explanations of step 306 are mentioned later with reference to FIG. 5 and FIGS. 6A to 6G.

Step 308 involves returning a unique identifier in response to adding a vehicle. When the new vehicle is added by the remote server 304, the remote server 304 will assign the unique identifier (e.g. 12BCA234546DFG) to the vehicle and return the same to consumer app 302. The unique identifier (hereinafter “vehicle ID”) is stored in a database together with the vehicle information received in step 306.

Step 310 involves backend processes performed at the vehicle and remote server 304. In one example, Bluetooth low energy devices (beacons) or RFID transponder devices may be installed in the vehicle for transmitting the vehicle ID to a pump controller or terminal at a gas station. And then, vehicle details, i.e. vehicle number, vehicle type etc. are collected from the vehicle. The vehicle details may include the size of the fuel tank and fuel preferences, i.e. fuel type, fuel grade etc. By using the collected information, the information on the added vehicle can be automatically updated. The user then adds payment details, such as a credit or debit account from which payment for refuelling can be drawn. Thereafter, the vehicle is authorised to refuel in accordance with present teachings.

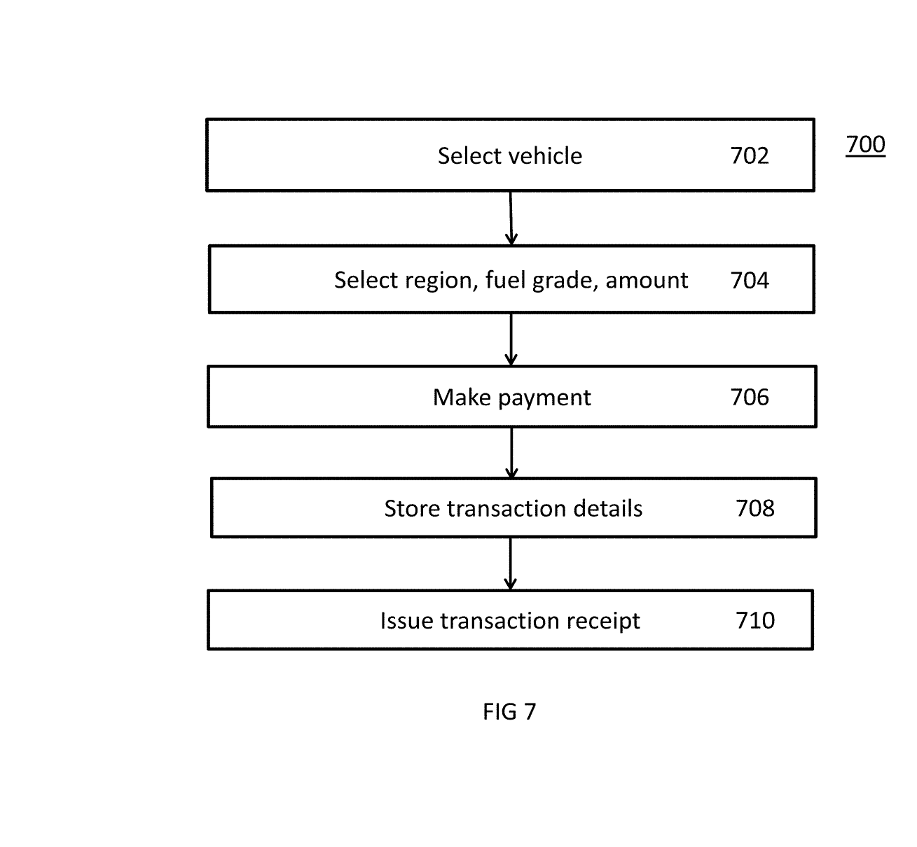

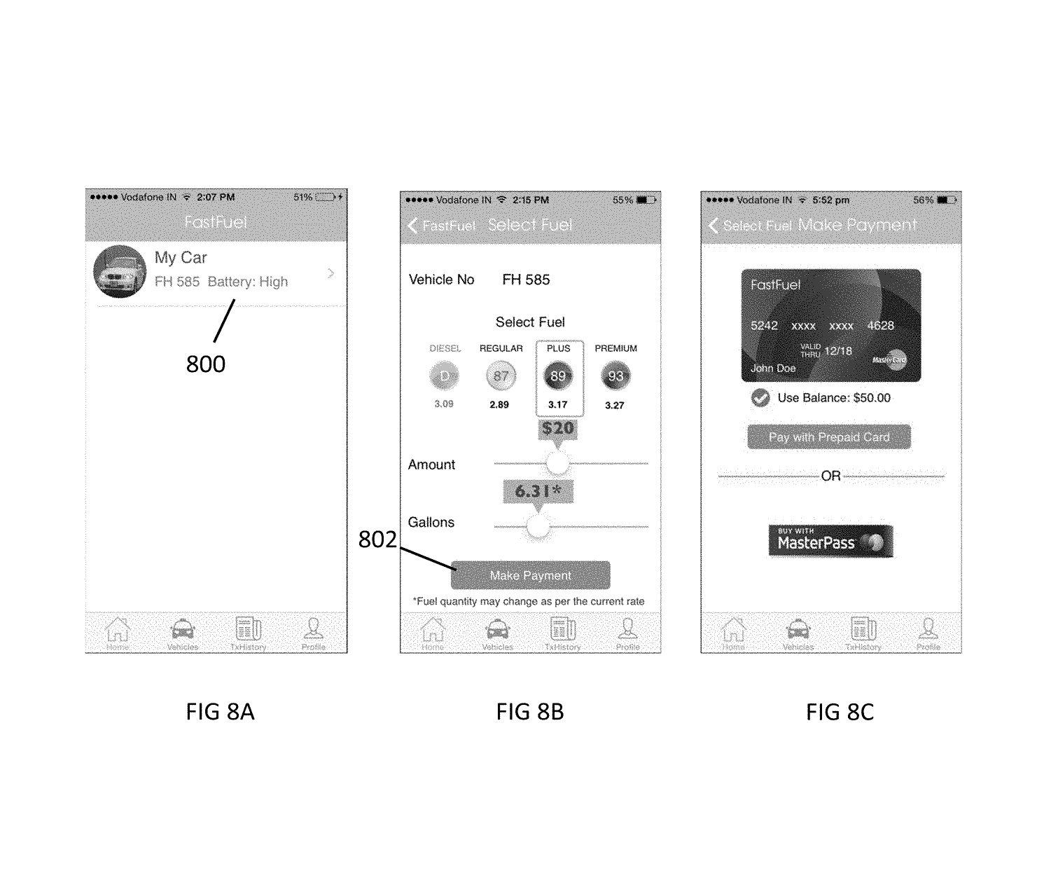

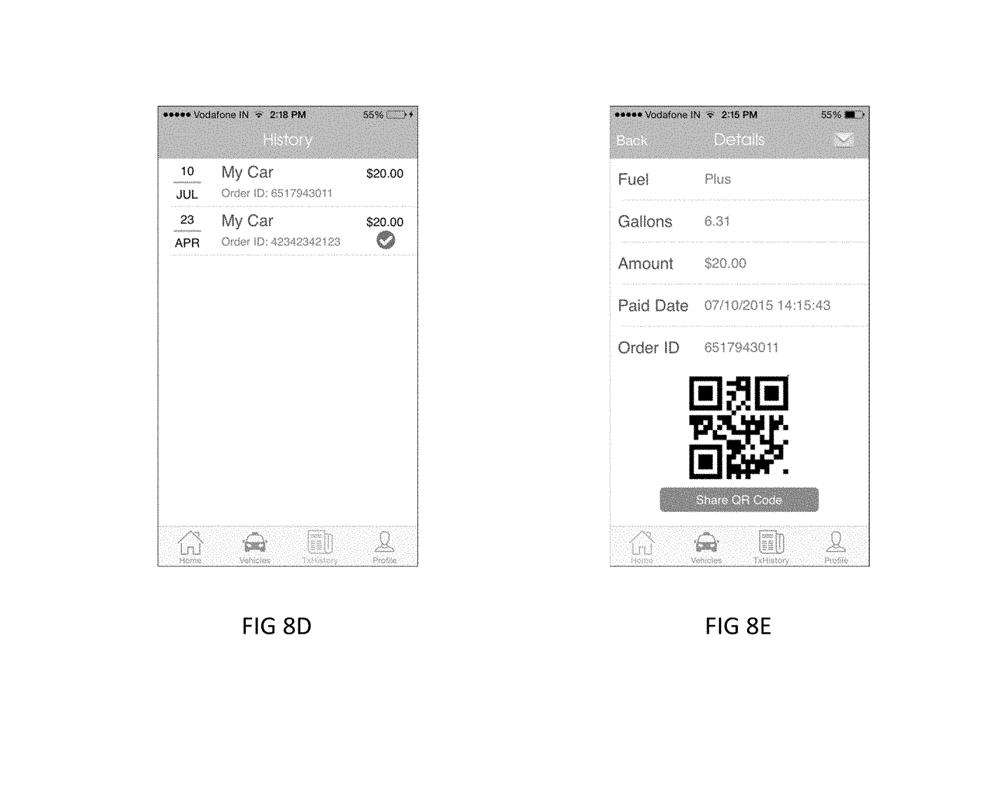

Step 312 involves making payment using the unique identifier of the vehicle. Users select fuel type, fuel grade, and amount of fuel for the vehicle and make payment for the selected fuel via prepaid card, credit card or any other type of payment method using the consumer application 302. The selected fuel and payment information may be sent to the remote server 304 together with the unique identifier of the vehicle. Detailed explanations of the step 312 are mentioned later with reference to FIG. 7 and FIGS. 8A to 8E.

Step 314 involves storing transaction details with vehicle ID at remote server 304. The system on remote server 304 receives the selected fuel and payment information from the consumer application 302. The selected fuel and payment information are linked with vehicle ID and stored in the system on the remote server 304 as transaction details. As a result, the transaction details can be retrieved using the vehicle ID for the vehicle.

Step 316 involves storing transaction details defining the transaction along with a transaction ID in a database and returning the same to the consumer application 302. Once the transaction details are stored, the remote server 304 returns the transaction details along with the transaction ID to the consumer application 302. The transaction ID can be used to retrieve transaction details from the remote server 304 in future. The transaction details may include a quick response (QR) code by which the transaction can be identifier, a vehicle ID, fuel type, fuel grade, quantity, paid date, region etc. The consumer application 302 receives transaction details together with transaction ID to confirm that payment has been made and the refuelling operation has been completed.

In one example, the vehicle ID is not mapped to the credit card details. Instead it is uniquely mapped to the transaction details. Even if the vehicle ID is compromised, only that particular transaction and vehicle details may be compromised if authentication also compromised. However, credit card details will not be compromised as the vehicle ID is not mapped directly to the credit card details.

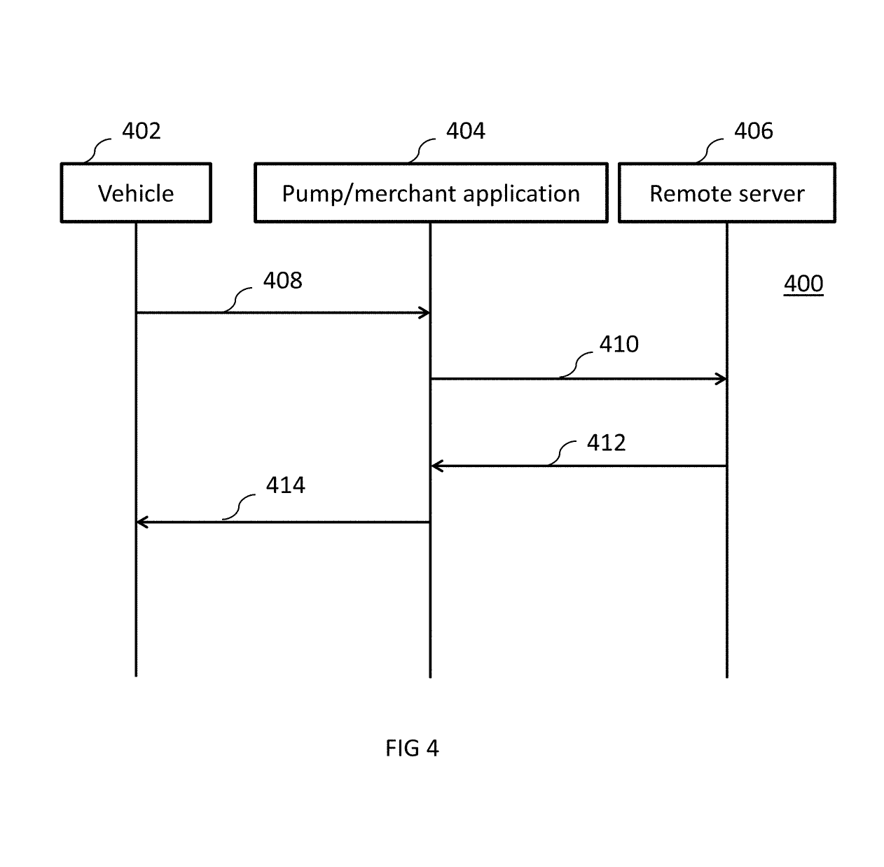

FIG. 4 shows a detailed workflow 400 illustrating transactions between vehicle 402, pump/merchant application 404 and remote server 406, according to present teachings. These transactions may be applicable to a gas station with or without an attendant. For gas stations with an attendant, merchant application 404 may be installed on a mobile computing device of the attendant. Alternatively, merchant application 404 may be installed on computer embedded in the fuel pump at the gas station. For gas stations without an attendant, the merchant application 404 requires additional features to facilitate pump control using a pump controller. The computer embedded in the pump is connected to the pump controller so that the pump is controllable based on instructions from the merchant application 404 installed on the computer.

Step 408 involves transmitting vehicle ID from a beacon device or an RFID transponder device installed in the vehicle 402. On the way to the gas station, the beacon device or the RFID transponder device transmits a vehicle ID. When the vehicle 402 reaches the proximity of the gas station or a particular pump, the vehicle ID transmitted from the beacon device or the RFID transponder device is detected by the pump/merchant application 404. For gas stations with an attendant, the merchant application 404 may alert the attendant that the vehicle 402 has reached the gas station or pump. For gas stations without an attendant, the merchant application 404 instructs the pump to switch to standby mode for dispensing fuel in response to the arrival of the vehicle 402.

Step 410 involves sending the vehicle ID to remote server 406 in order to fetch transaction details for the vehicle 402. In this scenario, a user of the vehicle 402 has already selected fuel and made payment and information of the selected fuel and payment are stored by the remote server 406, in association with the vehicle ID, prior to the vehicle arriving at the gas station. Since transaction details are mapped to the vehicle ID, the transaction details of the vehicle 402 can be retrieved using the vehicle ID once the vehicle 402 has reached the gas station. Retrieval of the information may be automatic, upon receipt of the vehicle ID by the computing system at the gas station.

Step 412 involves returning transaction details from remote server 406. If the remote server 406 successfully returns transaction details to merchant application 404, the merchant application 404 shows the transaction details to the attendant. The attendant obtains vehicle information from merchant application 404 and verifies whether or not the vehicle 402 arriving at the gas station is the vehicle 402 shown on the transaction details. This may be achieved by comparing the physical vehicle to vehicle information such as a picture of vehicle, registration number or other details.

If the remote server 406 cannot find relevant transaction details based on the vehicle ID, the remote server 406 returns an error message to the merchant application. In such a case, the attendant cannot obtain vehicle information from the merchant application 404. Accordingly, the attendant may ask user of the vehicle 402 to show the transaction details on the consumer application of the user. In one example, the transaction details include a QR code for scanning by the attendant using a device on which the merchant application 404 is installed. The server 406 can then confirm the transaction details or alert the attendant that no such transaction exists.

For self-service pumps without an attendant, the user may scan the QR code using a scanner connected to the pump, and the remote server 406 can again verify the transaction details. Alternatively, the user may input vehicle information into the computing system at the pump, by which completion of the payment transaction can be verified.

Step 414 involves dispensing fuel in response to successful authentication. For gas stations with an attendant, the attendant fills the vehicle 402 with fuel in accordance with transaction details on merchant application 404. If the tank of the vehicle 402 becomes full before completion of fuel dispensing as instructed in the transaction details, the remaining dollar value of fuel that was not dispensed may be put on deposit in a prepaid account of the user. The user may use the deposit in the prepaid account during subsequent refuelling operations.

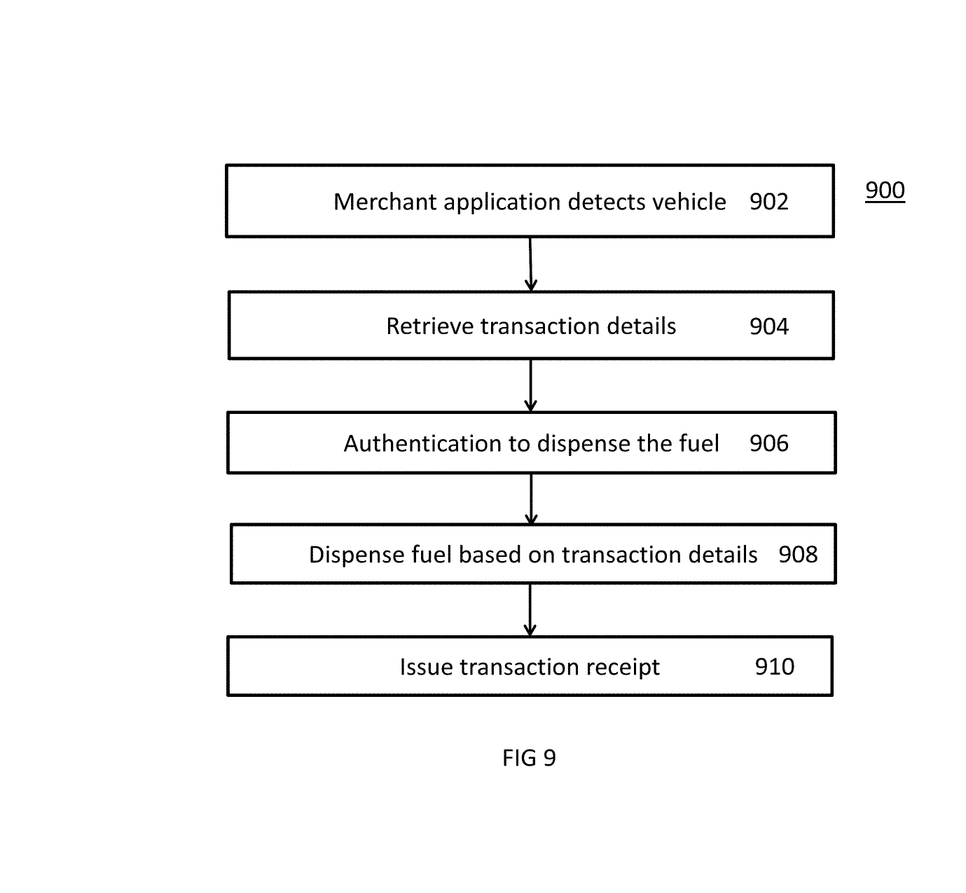

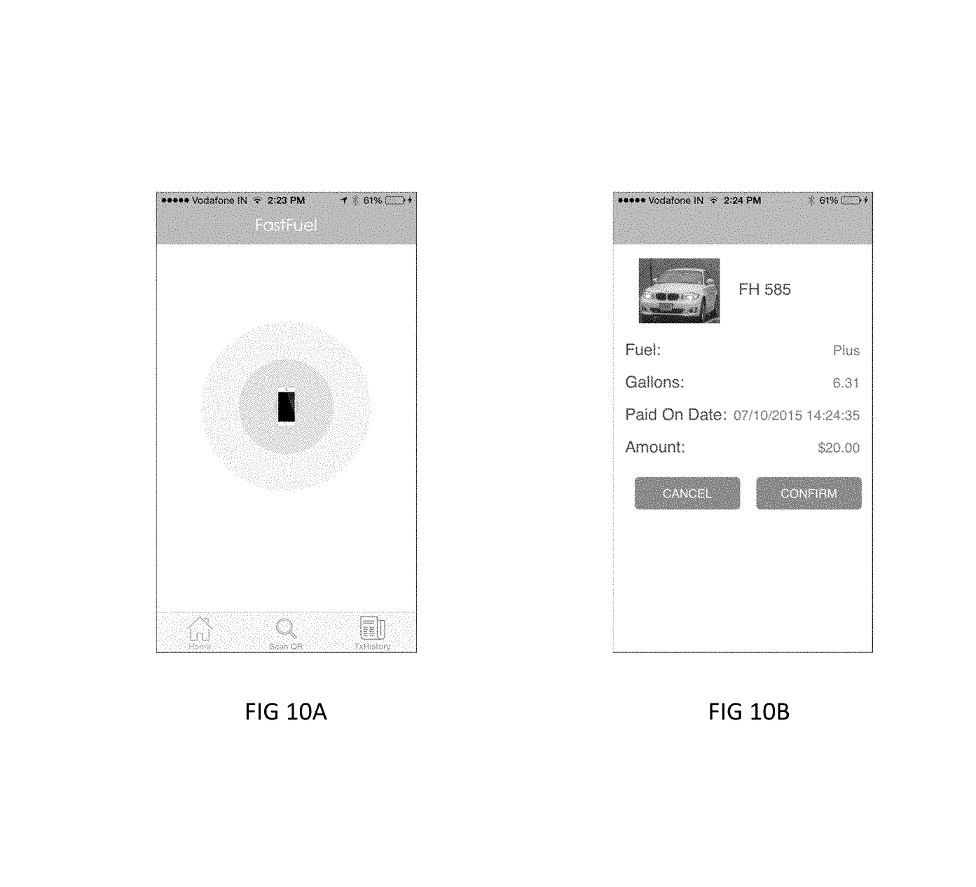

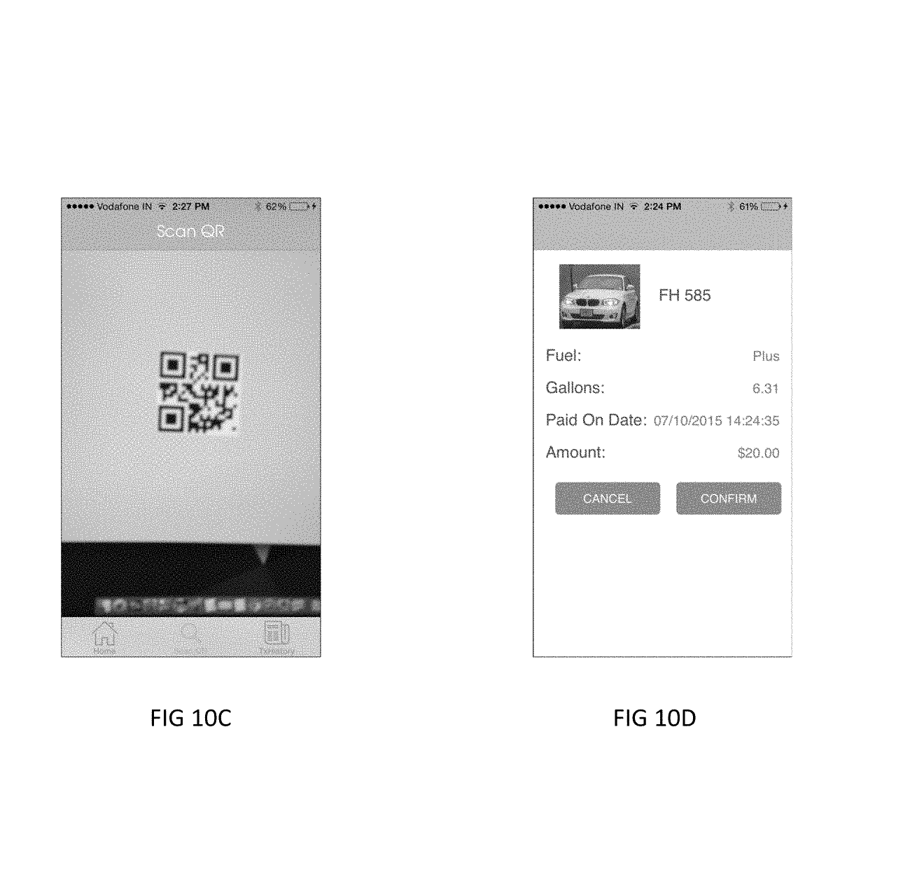

For gas stations without an attendant, the user needs to fill the vehicle 402 with fuel. Prior to activating pump, the user may be required to enter a passcode (e.g. a PIN code) for authentication, thereby enabling the user to be authenticated. Once user is authenticated, the pump will be activated. When the pump is activated, the pump controller controls the pump by e.g. opening/closing valve of the pump so that the specific type/grade/quantity of fuel is dispensed as instructed in the transaction details. Detailed explanations of the steps 408 to 414 are mentioned later with reference to FIG. 9 and FIGS. 10A to 10D.

FIG. 5 shows a flow chart 500 illustrating a method for adding a vehicle to the system using the consumer app, according to present teachings. FIGS. 6A to 6G show a user interface of a consumer application for adding a vehicle to the system. Each of the steps 502, 504, 506, 508 and 510 in the flow chart 500 is conducted through the consumer application or vehicle. In this scenario, the consumer application has already been installed on a mobile computing device of the user or computer embedded in the vehicle.

Step 502 involves launching the consumer application. An exemplary user interface for the step 502 is shown in FIG. 6A. Although the name of the consumer application 600 is shown on the launching screen, other types of information can be shown on the launching screen.

Step 504 involves signing into the application. The user may sign into the application using a unique user identifier (e.g. a predetermined PIN code or password or biometric verification such as a fingerprint). If the user does not have account for the application, the user may register the user information and determine a unique user identifier such as a PIN code or password in order to register for an account.

Step 506 involves sending a request to the remote server to add a vehicle to the user account. An exemplary user interface for step 506 is shown on FIG. 6B. In this example, the user clicks on Vehicles Tab 602 to see a list of all the vehicles added in their account. If no vehicle is added to the user account, only one button “ADD VEHICLE” 604 is shown. To add a vehicle, the user clicks the button “ADD VEHICLE” 604. In response to the click of the button 604, the consumer app sends to the remote server a request to add a vehicle. In response to the request to add a vehicle, the consumer application guides the user in the collection of vehicle information to assist with refuelling operations. In some cases, payment details may also be allocated to particular vehicles so that, for example, refuelling of vehicles used for business purposes is charged to a particular credit or debit account, or refuelling of vehicles used for non-business purposes is charged to a different account.

Step 508 involves sending vehicle details to the remote server. In one example, a picture of the vehicle can be selected as shown on FIG. 6C. Since the picture of the vehicle may be used for verification of the vehicle by the attendant, the vehicle number may be required to be visible in the picture. In addition, a nickname of the vehicle can be inputted as shown on FIG. 6D. The picture and nickname of the vehicle may be sent to the remote server for storing in a database for subsequent retrieval during refuelling operations. Once the vehicle information is sent to the remote server, the user interface of the consumer application shows a confirmation alert as shown on FIG. 6E. In response to the confirmation, backend process is initiated, which includes physical device installation and collection of further details of the vehicle (step 510).

Step 510 involves initiating the backend process. In one example, the backend process includes installing a Bluetooth beacon device in vehicle or attaching an RFID transponder device to an electronic license plate or elsewhere on the vehicle. The backend process may also include collecting further details of the vehicle i.e. vehicle number, vehicle type etc. The backend process may further include collecting vehicle fuel preferences, i.e. fuel type, fuel grade etc. Based on the collected information, the system on remote server is updated and the vehicle is activated for refuelling operations using the present methods.

Once the vehicle is activated in the system, the added vehicle 606 is shown on vehicle tab as shown in FIG. 6F. By selecting vehicle, the user can edit the preferences relating to the vehicle. If a beacon device or an RFID transponder device of the vehicle does not work properly, the user can request a new beacon device or a new RFID transponder device from the page shown in FIG. 6G. Battery life of the beacon device or the new RFID transponder device can also be checked in the consumer application. For example, the battery life can be indicated at vehicle information 800 of FIG. 8A.

FIG. 7 shows a flow chart 700 illustrating a method for selecting fuel and making payment on the system using the consumer app, according to present teachings. FIGS. 8A to 8E show a user interface of a consumer application for selecting fuel and making payment. Each of the steps 702, 704, 706, 708 and 710 in the flow chart 700 is conducted at the consumer application or through a remote server. In this scenario, the vehicle has already been registered in the system on the remote server—in other words, the vehicle has been added as described with reference to FIGS. 5 and 6.

Step 702 involves selecting a vehicle for refuelling. An exemplary user interface for the step 702 is shown in FIG. 8A. The selected vehicle 800 is shown on the user interface. After selecting the vehicle 800, the user can select fuel for the vehicle 800.

Step 704 involves selecting region, fuel grade, and amount or quantity of the fuel. An exemplary user interface for the step 704 is shown in FIG. 8B. In this example, the user may select fuel from diesel, regular, plus and premium. Octane rating (e.g. Research Octane Number (RON) or Anti-Knock Index (AKI)) and price for each type of fuel is indicated. The quantity of the fuel can be selected by the dollar value of the fuel or by specifying the volume or quantity of fuel to be dispensed. For example, a user can buy US$ 20 of fuel. The actual quantity is automatically calculated based on the price of the fuel at the gas station. Alternatively, the user can buy 6.31 Gallons of fuel. The value of 6.31 Gallons is automatically calculated based the price of the fuel at the gas station. The unit of quantity such as Gallons or Litres can be configured based on the region of the gas station. Local currency is used for the price. Indication of Octane rating also follows regional preference. Once the selection of fuel is completed, the user may click “make payment” 802 to proceed to next step.

Step 706 involves making payment. An exemplary user interface for the step 706 is shown on FIG. 8C. In this example, the user may choose from one of a plurality of payment options: presently, the options are payment via either prepaid card or digital wallet. In some cases, the user may use a credit card without a digital wallet. In one example, payment would be valid on the same day only. If the user does not refuel on the day payment is made, the money would be credited to the prepaid card or payment vehicle that was debited (or on which funds were blocked) to make payment for the refuelling operation. Notably, a user may provide their payment details for paying for refuelling of multiple cars. The user corresponding to the payment details (e.g. the account holder) does not need to be the same as the registered owner or the user of any particular vehicle. In this manner, a user may pay for refuelling the vehicles of family or friends. Similarly, a business may have a fuel account that pays for refuelling employees' cars regardless of the individuals' names or the business entity under which those cars are registered.

Step 708 involves storing transaction details in the database of a remote server. Once selection of fuel and payment are completed, the transaction details are stored in the database. The transaction details may include vehicle ID, fuel grade, quantity of fuel, amount paid for the fuel, date and time of the payment, transaction ID for the transaction and other relevant details. In addition, the remote server may store the vehicle ID together with transaction details so that the transaction details can be retrieved using the vehicle ID.

Step 710 involves issuing transaction details. Once payment is made, the user will see the transaction in the transaction history shown in FIG. 8D. If the user clicks on one of the transactions, the transaction details for the selected transaction will be shown per FIG. 8E. Where a refuelling operation is yet to take place, the transaction may be shown as ‘pending’ and, similarly, after refuelling the transaction may be shown as ‘completed’.

In one example, the transaction details may include a QR code for use where the merchant application is not supplied with, or cannot locate, the transaction. If merchant application cannot retrieve the transaction details, the user can show the QR code so that an attendant, or a server connected to a pump controller, can retrieve the transaction details. Alternatively, the QR code can be shared with family if the users have made payment on their behalf. Since the QR code is just an exemplary expression of information, any other type of expression (e.g. barcode) can be included in the transaction details. Furthermore, the transaction details can be shared via email. In other words, it is not necessary to install the consumer app on every mobile device to perform refuelling operations provided the representation can be produced at the gas station, by which payment for refuelling can be confirmed. Where, for example, the battery life of a mobile computer in which the consumer application is installed is very low, the user may forward the transaction details to another occupant in the vehicle after completion of payment so that the other occupant can show the transaction details to the attendant or pump at the gas station.

FIG. 9 shows a flow chart 900 illustrating a method for authorizing a vehicle for refuelling using a merchant app, according to present teachings. FIGS. 10A to 10D show a user interface of merchant application for authorizing refuelling. Each of steps 902, 904, 906, 908 and 910 in the flow chart 900 is conducted at a merchant application or pump (i.e. using a computing system embedded in the pump). In this scenario, the vehicle to be refuelled has already arrived at the gas station.

Step 902 involves detecting the vehicle using the merchant application. An exemplary user interface for the step 902 is shown in FIG. 10A. If the beacon signal or RFID signal of the vehicle is successfully detected by the merchant application, the merchant application sends the vehicle ID to the remote server. The remote server retrieves transaction details from a database and returns those details to the merchant application.

Step 904 involves retrieving transaction details. If the merchant application can successfully retrieve transaction details from the remote server, the transaction details are displayed as shown in FIG. 10B. If the merchant application cannot retrieve transaction details using the vehicle ID, the merchant (e.g. attendant or computing system embedded in a pump) may refer to transaction details or a references (e.g. QR-code) displayed on the consumer application. In other words, the user may be asked to show details of a transaction made before arriving at the gas station. In one example, the merchant application is installed in a device with scanning capabilities for scanning a QR code by which the transaction details can be retrieved. An exemplary scanning interface of the merchant application is shown on FIG. 10C. By scanning the QR code, the transaction details can be retrieved from remote server as shown in FIG. 10D.

Step 906 involves authorizing refuelling. Once the vehicle is identified or verified and transaction details are confirmed, the pump at the gas station is authorized to refuel the vehicle. For a gas station with an attendant, authentication of the vehicle can be conducted by the attendant. However, for a gas station without an attendant, authentication means may be incorporated into the pump itself so that unauthorized usage of the pump can be prohibited, or may be linked to video feed of a camera mounted at the gas station and connected to the pump controller, so that visual confirmation of the identity of the vehicle can be performed.

Step 908 involves filling the vehicle with fuel using the transaction details. Since the type of fuel and amount of fuel have already been determined and are specified in the transaction details, it is not necessary to ask the driver any questions. If an attendant is available, the attendant follows the transaction details and proceeds to fill the vehicle in accordance with the transaction details. For self-service pumps, the pump controller may control the nozzle valve so that the specified amount of fuel is dispensed.

Step 910 involves issuing a transaction receipt. Once refuelling is complete, the user receives a digital receipt. The completion of refuelling is also recorded in the database of the remote server for avoiding reuse of the transaction details.

Various discount and loyalty award schemes can be provided to consumers as a reward for using the system. The loyalty points may be redeemed in the convenience stores at the gas station, which can increase the sales at the convenience stores.

Since payment is not required at the gas station, the system is useful for bus or taxi service organizations. Such transportation organizations can monitor all payment transactions for refuelling operations. The company may pay for the fuel on behalf of the driver in the morning so that the driver can refuel at a gas station when it is necessary on the day, but may disable refuelling operations using particular accounts for periods when the relevant vehicle is not expected to be in use.

FIG. 11 shows a schematic of a network-based system 1100 for facilitating filling a vehicle with fuel according to an embodiment of the invention. The system 400 comprises a computer 1102, one or more databases 1104a . . . 1104n, a user input module 1106 and a user output module 1108. Each of the one or more databases 1104a . . . 1104n are communicatively coupled with the computer 1102. The user input module 1106 and a user output module 1108 may be separate and distinct modules communicatively coupled with the computer 1102. Alternatively, the user input module 1106 and a user output module 1108 may be integrated within a single mobile electronic device (e.g. a mobile phone, a tablet computer, etc.). The mobile electronic device may have appropriate communication modules for wireless communication with the computer 1102 via existing communication protocols.

The computer 1102 may comprise: at least one processor; and at least one memory including computer program code; the at least one memory and the computer program code configured to, with at least one processor, cause the computer at least to: (A) receive an identifier of the vehicle from the vehicle; (B) retrieve payment details for the fuel from a remote server using the identifier; and (C) authorize filling the vehicle with fuel in accordance with the payment details.

The various types of data, e.g. vehicle data, payment information, location information, fuel information, gas station information, price of fuel, can be stored in a single database (e.g. 1104a), or stored in multiple databases (e.g. vehicle information are stored on database 1104a, gas station information are stored on database 1104n, etc.). The databases 1104a . . . 1104n may be realized using cloud computing storage modules and/or dedicated servers communicatively coupled with the computer 1102.

FIG. 12 depicts an exemplary computer/computing device 1200, hereinafter interchangeably referred to as a computer system 1200, where one or more such computing devices 1200 may be used to facilitate execution of the above-described method for facilitating filling a vehicle with fuel. In addition, one or more components of the computer system 1200 may be used to realize the computer 1102. The following description of the computing device 1200 is provided by way of example only and is not intended to be limiting.

As shown in FIG. 12, the example computing device 1200 includes a processor 1204 for executing software routines. Although a single processor is shown for the sake of clarity, the computing device 1200 may also include a multi-processor system. The processor 1204 is connected to a communication infrastructure 1206 for communication with other components of the computing device 1200. The communication infrastructure 1206 may include, for example, a communications bus, cross-bar, or network.

The computing device 1200 further includes a main memory 1208, such as a random access memory (RAM), and a secondary memory 1210. The secondary memory 1210 may include, for example, a storage drive 1212, which may be a hard disk drive, a solid state drive or a hybrid drive and/or a removable storage drive 1214, which may include a magnetic tape drive, an optical disk drive, a solid state storage drive (such as a USB flash drive, a flash memory device, a solid state drive or a memory card), or the like. The removable storage drive 1214 reads from and/or writes to a removable storage medium 1244 in a well-known manner. The removable storage medium 1244 may include magnetic tape, optical disk, non-volatile memory storage medium, or the like, which is read by and written to by removable storage drive 1214. As will be appreciated by persons skilled in the relevant art(s), the removable storage medium 1244 includes a computer readable storage medium having stored therein computer executable program code instructions and/or data.

In an alternative implementation, the secondary memory 1210 may additionally or alternatively include other similar means for allowing computer programs or other instructions to be loaded into the computing device 1200. Such means can include, for example, a removable storage unit 1222 and an interface 1240. Examples of a removable storage unit 1222 and interface 1240 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1222 and interfaces 1240 which allow software and data to be transferred from the removable storage unit 1222 to the computer system 1200.

The computing device 1200 also includes at least one communication interface 524. The communication interface 1224 allows software and data to be transferred between computing device 1200 and external devices via a communication path 1226. In various embodiments of the inventions, the communication interface 1224 permits data to be transferred between the computing device 1200 and a data communication network, such as a public data or private data communication network. The communication interface 1224 may be used to exchange data between different computing devices 1200 which such computing devices 1200 form part an interconnected computer network. Examples of a communication interface 1224 can include a modem, a network interface (such as an Ethernet card), a communication port (such as a serial, parallel, printer, GPIB, IEEE 1393, RJ35, USB), an antenna with associated circuitry and the like. The communication interface 1224 may be wired or may be wireless. Software and data transferred via the communication interface 1224 are in the form of signals which can be electronic, electromagnetic, optical or other signals capable of being received by communication interface 1224. These signals are provided to the communication interface via the communication path 1226.

As shown in FIG. 12, the computing device 1200 further includes a display interface 1202 which performs operations for rendering images to an associated display 1230 and an audio interface 1232 for performing operations for playing audio content via associated speaker(s) 1234.

As used herein, the term “computer program product” may refer, in part, to removable storage medium 1244, removable storage unit 1222, a hard disk installed in storage drive 1212, or a carrier wave carrying software over communication path 1226 (wireless link or cable) to communication interface 1224. Computer readable storage media refers to any non-transitory, non-volatile tangible storage medium that provides recorded instructions and/or data to the computing device 1200 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 1200. Examples of transitory or non-tangible computer readable transmission media that may also participate in the provision of software, application programs, instructions and/or data to the computing device 1100 include radio or infra-red transmission channels as well as a network connection to another computer or networked device, and the Internet or Intranets including e-mail transmissions and information recorded on Websites and the like.

The computer programs (also called computer program code) are stored in main memory 1208 and/or secondary memory 1210. Computer programs can also be received via the communication interface 1224. Such computer programs, when executed, enable the computing device 1200 to perform one or more features of embodiments discussed herein. In various embodiments, the computer programs, when executed, enable the processor 1204 to perform features of the above-described embodiments. Accordingly, such computer programs represent controllers of the computer system 1200.

Software may be stored in a computer program product and loaded into the computing device 1200 using the removable storage drive 1214, the storage drive 1212, or the interface 1240. Alternatively, the computer program product may be downloaded to the computer system 1200 over the communications path 1226. The software, when executed by the processor 1204, causes the computing device 1200 to perform functions of embodiments described herein.

It is to be understood that the embodiment of FIG. 12 is presented merely by way of example. Therefore, in some embodiments one or more features of the computing device 1200 may be omitted. Also, in some embodiments, one or more features of the computing device 1200 may be combined together. Additionally, in some embodiments, one or more features of the computing device 1200 may be split into one or more component parts.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A computer-implemented method for facilitating dispensing of fuel into a vehicle, comprising:
receiving, from the vehicle, a vehicle identifier for identifying the vehicle;
retrieving payment details, for payment for the fuel, from a remote server based on the vehicle identifier; and
authorizing dispensing the fuel into the vehicle in accordance with the payment details.

2. The method in accordance with claim 1, wherein the receiving step includes receiving a beacon signal including the vehicle identifier from a beacon device installed on the vehicle.

3. The method in accordance with claim 1, wherein the receiving step includes receiving a transponder signal including the vehicle identifier from an RFID transponder device installed on the vehicle.

4. The method in accordance with claim 1, wherein the payment details include at least one of a fuel type, fuel grade, quantity, vehicle image and vehicle identification number (VIN).

5. The method in accordance with claim 1, further comprising authenticating the vehicle with the identifier of the vehicle.

6. The method in accordance with claim 1, wherein the authorizing step includes displaying payment details so that the fuel is dispensed into the vehicle in accordance with the payment details.

7. The method in accordance with claim 1, wherein the authorizing step includes instructing a fuel pump to dispense the fuel into the vehicle in accordance with the payment details.

8. A computer-implemented method for facilitating dispensing of fuel into a vehicle, comprising:
receiving vehicle information of the vehicle;
issuing an identifier of the vehicle based on the vehicle information;
offering a plurality of fuel selections for dispensing into the vehicle;
receiving a selected fuel selection, payment details and the identifier; and
authorizing dispensing of the selected fuel selection into the vehicle identified by the identifier, in accordance with the payment details.

9. The method in accordance with claim 8, wherein offering a plurality of fuel selections comprises offering a plurality of fuel selections wherein each selection comprises at least one of a fuel type, fuel grade and quantity of fuel to be dispensed.

10. The method in accordance with claim 9, wherein the one or more of the fuel selections is offered based on the vehicle information.

11. The method in accordance with claim 8, wherein the authorising step includes sending information on selected fuel to be dispensed and relevant payment together with the identifier.

12. The method in accordance with claim 8, wherein the authorising step includes allowing a fuel pump to dispense the selected fuel into the vehicle identified by the identifier.

13. The method in accordance with claim 8, wherein the payment details comprise credit card details, the method further comprising debiting the credit card in an amount sufficient to pay for the fuel.

14. The method in accordance with claim 8, wherein the payment details comprise debit or pre-paid card details, the method further comprising debiting the debit or pre-paid card in an amount sufficient to pay for the fuel.

15. The method in accordance with claim 8, wherein the payment details comprise a unique vehicle identifier and a unique user identifier, the method further comprising transmitting the unique vehicle identifier and the unique user identifier to a financial institution for association with a payment vehicle from which can be debited an amount sufficient to pay for the fuel.

16. A computing system for facilitating dispensing of fuel into a vehicle, comprising a receiver for receiving an identifier of the vehicle from the vehicle, a retrieving module for retrieving payment details for the fuel from a remote server using the identifier, an authorizing module for authorizing the dispensing of the fuel into the vehicle in accordance with the payment details.

17. The computing system in accordance with claim 16, wherein the receiver receives a beacon signal including the vehicle identifier from a beacon device installed on the vehicle.

18. The computing system in accordance with claim 16, wherein the payment details include at least one of a fuel type, fuel grade, quantity, vehicle image and vehicle identification number (VIN).

19. The computing system in accordance with claim 16, further comprising authenticating module for authenticating the vehicle with the identifier of the vehicle.

20. The computing system in accordance with claim 16, wherein the authorizing module displays payment details so that the fuel is dispensed into the vehicle in accordance with the payment details.

21. The computing system in accordance with claim 16, wherein the authorising module instructs a fuel pump to dispense the fuel into the vehicle in accordance with the payment details.

22. A computing system for facilitating dispensing of fuel into a vehicle, comprising:
a receiver for receiving vehicle information of the vehicle;
an issuing module for issuing an identifier of the vehicle based on the vehicle information;
an offering module for offering a plurality of fuel selections for dispensing into the vehicle;
a receiver for receiving a selected fuel selection, payment details and the identifier; and
an authorizing module for authorizing dispensing of the selected fuel selection into the vehicle identified by the identifier, in accordance with the payment details.

23. The computing system in accordance with claim 22, wherein the offering module offers a plurality of fuel selections wherein each selection comprises at least one of a fuel type, fuel grade and quantity of fuel to be dispensed.

24. The computing system in accordance with claim 23, wherein the one or more of the fuel selections is offered based on the vehicle information.

25. The computing system in accordance with claim 22, wherein the authorising module sends information on selected fuel to be dispensed and relevant payment together with the identifier.

26. The computing system in accordance with claim 22, wherein the authorising module allows a fuel pump to dispense the selected fuel into the vehicle identified by the identifier.

27. The computing system in accordance with claim 22, wherein the payment details comprise credit card details, the computing system further comprising debiting module for debiting the credit card in an amount sufficient to pay for the fuel.

28. The computing system in accordance with claim 22, wherein the payment details comprise debit or pre-paid card details, the computing system further comprising debiting module for debiting the debit or pre-paid card in an amount sufficient to pay for the fuel.

29. The computing system in accordance with claim 22, wherein the payment details comprise a unique vehicle identifier and a unique user identifier, the computing system further comprising a transmitter for transmitting the unique vehicle identifier and the unique user identifier to a financial institution for association with a payment vehicle from which can be debited an amount sufficient to pay for the fuel.
